(19) United States
(12) Patent Application Publication
(10) Pub. No.: US 2008/0270201 A1
(43) Pub. Date: Oct. 30, 2008

(54) METHOD AND SYSTEM FOR MODELING SERVICES IN A SERVICE-ORIENTED BUSINESS

(75) Inventors: David Flaxer, Port Hadlock, WA (US); David Marston, Cambridge, MA (US); Nitinchandra Ratankumar Nayak, Ossining, NY (US); Anil Nigam, Stamford, CT (US); Jorge Luciano Claudio Sanz, Pebble Beach, CA (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: INTERNATIONAL BUSINESS MACHINES CORPORATION, Armonk, NY (US)

(21) Appl. No.: 11/742,088

(22) Filed: Apr. 30, 2007

(51) Int. Cl. G06Q 99/00

(52) U.S. Cl. 705/7

(57) ABSTRACT

A method of modeling a service-oriented business including identifying a business service to provide, creating its business specification which specifies business requirements for the provided service, the business specification of a service, and service management terms, storing the business specification for the provided service in a service catalog, creating and reviewing its business process model, the business process model providing a sequence of business tasks in the business process, analyzing each of the business tasks to determine which of the business tasks should be accomplished via required service, process modeling each of the business tasks that are not service tasks, storing a process model for each of the business tasks that are not service tasks in a operation model repository, creating a business specification for each required service and storing the business specification for each of the required services in a repository of business specifications of required services.

### BACKGROUND OF THE INVENTION

1. Field of the Invention

The present invention generally relates to a method and system for modeling business services in the context of a service-oriented business and, more particularly, to a method and system for modeling business services in which a user is enabled to represent services either consumed within business operations or services provided through a provider's business operations.

2. Description of the Related Art

The present invention addresses the modeling needs of business architects who wish to design business operations that consume services as well as design the business operations to provide services. By treating services as a first class construct in modeling business operations, the communication between service consumers and service providers as well as between service providers and service implementers is improved through the richness of semantics.

For purposes of the present application, a service-oriented business refers to a business that either consumes services as a part of their business operations or provides services realized through their business operations. The present invention will help a service-oriented business design business operations using services as a first class construct rather than as an afterthought, better communicate the service expectations between service consumers and service providers as well as between service providers and service implementers, and improve business operations from the perspective of both consuming services from other providers as well as providing services to other consumers.

Modeling a service-oriented business requires the ability to model services consumed within a business process as well as services provided by a service provider. However, the current model of “service” such as web services, which has been designed with application integration and inter-operability in mind, is not suitable for modeling service-oriented businesses. It does not support the modeling needs of business architects who would like to describe services that their business operations either consume or provide. Hence, there is a need for a service model supported by a method and appropriate tools that will allow business architects to communicate elements of a service from the perspective of both service consumers as well as service providers in a service-oriented business.

### SUMMARY OF THE INVENTION

In view of the foregoing and other exemplary problems, drawbacks, and disadvantages of the conventional methods and structures, an exemplary feature of the present invention is to

In accordance with a first exemplary aspect of the present invention, a method of modeling a business service within the context of a service-oriented business includes identifying a business service to provide, based on at least one of a consumer request, market needs, capability analysis, and strategic analysis; creating the business specification for the provided service, the business specification of a service specifying business requirements for the service; the business specification of a service comprising details of the business service including a description of a functions of the business service, service consumption terms, service performance terms, and service management terms; storing the business specification of the service for each of the service tasks in a provided service catalog; creating and reviewing a business process model of each provided service function, the business process model describing a sequence of business tasks; analyzing each of the business tasks to determine which of the business tasks should be performed using required service functions (also known as service tasks); modeling the process decomposition of each of the business tasks that are not service tasks; storing the process model for each of the decomposed business tasks in a operation model repository; creating a business specification of the required service for each of the service tasks based on at least one of a service provider and a service consumer, the business specification of a service specifying business requirements for the service; the business specification of a service comprising details of the business service including a description of a functions of the business service, service consumption terms, service performance terms, and service management terms; storing the business specification of the service for each of the service tasks in a repository of business specifications of services.

The Unified Service Model (USM) of the present invention enables business architects to represent services either consumed within business operations or services provided through a provider's business operations. Elements of the USM help communicate service-related information between a service consumer and a service provider, as well as between a service provider and a service implementer. The present invention also provides a method for modeling the consumption and provisioning of services and a business service modeling tool used for this purpose.

As indicated above, the present invention will help a service-oriented business design its business operations using services as a first class construct rather than as an afterthought, better communicate the service expectations between service consumers and service providers as well as between service providers and service implementers, and improve business operations from the two perspectives of consuming services from other providers as well as providing services to other consumers.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 graphically illustrates a relationship between a service consumer and a service provider;

FIG. 2 graphically illustrates a high-level model for a business service design;

FIG. 3 graphically illustrates exemplary service specification details;

FIG. 4 graphically illustrates an exemplary service hierarchy based on recursion;

FIG. 5 graphically illustrates a service-oriented business modeling method for a service consumer in accordance with an exemplary embodiment of the present invention;

FIG. 6 graphically illustrates a service-oriented business modeling method for a service provider in accordance with an exemplary embodiment of the present invention; and

FIG. 7 illustrates an overview of exemplary integrated tools for service-oriented business modeling.

### DETAILED DESCRIPTION OF EXEMPLARY EMBODIMENTS OF THE INVENTION

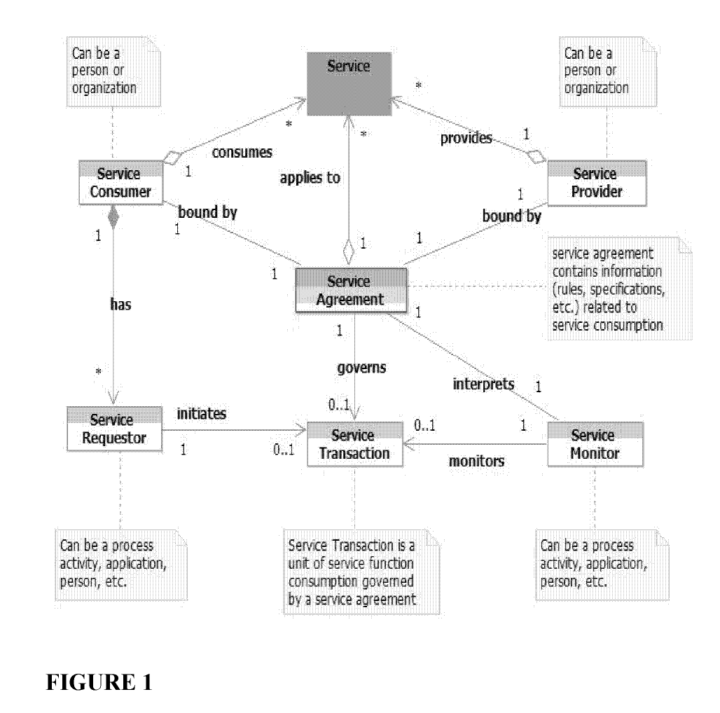

Referring now to the drawings, and more particularly to FIGS. 1-7, there are shown exemplary embodiments of the method and structures according to the present invention.

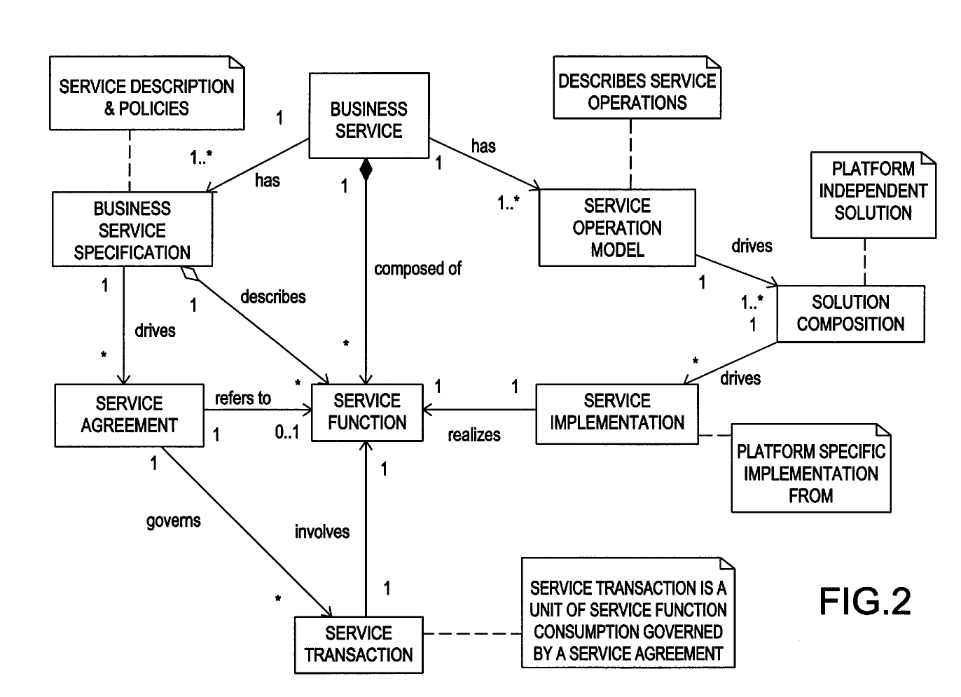

FIG. 1 depicts the context associated with providing and consuming services in a service-oriented business. For purposes of the present invention, a service refers to a set of value-added functions provided by a service provider that is of value to service consumer. The consumption of a service function is a service transaction, as described in the service agreement. Both provided services and requested services are types of service and so have similar structures as shown in FIG. 2.

A service consumer is a person or organization that contracts with a service provider to consume provided service functions under a service agreement.

A service provider is a person or organization that is responsible for providing a service to satisfy a request for a service function in accordance with a service agreement.

A service requestor is an entity related to the service consumer that actually initiates a service transaction with the service provider. This entity can be a process activity, application, or person.

A service agreement is the agreement between the service consumer and the service provider that governs the service transaction and how the service is provided and consumed. This agreement is a type of business commitment between service consumer and service provider that is agreeable to both parties.

A service monitor is an entity that interprets the service agreement terms and conditions, monitors the service transaction using an appropriate mechanism, measures service consumption parameters, and flags any out-of-bound situations.

A service transaction is a unit of service function consumption and governed by the service agreement.

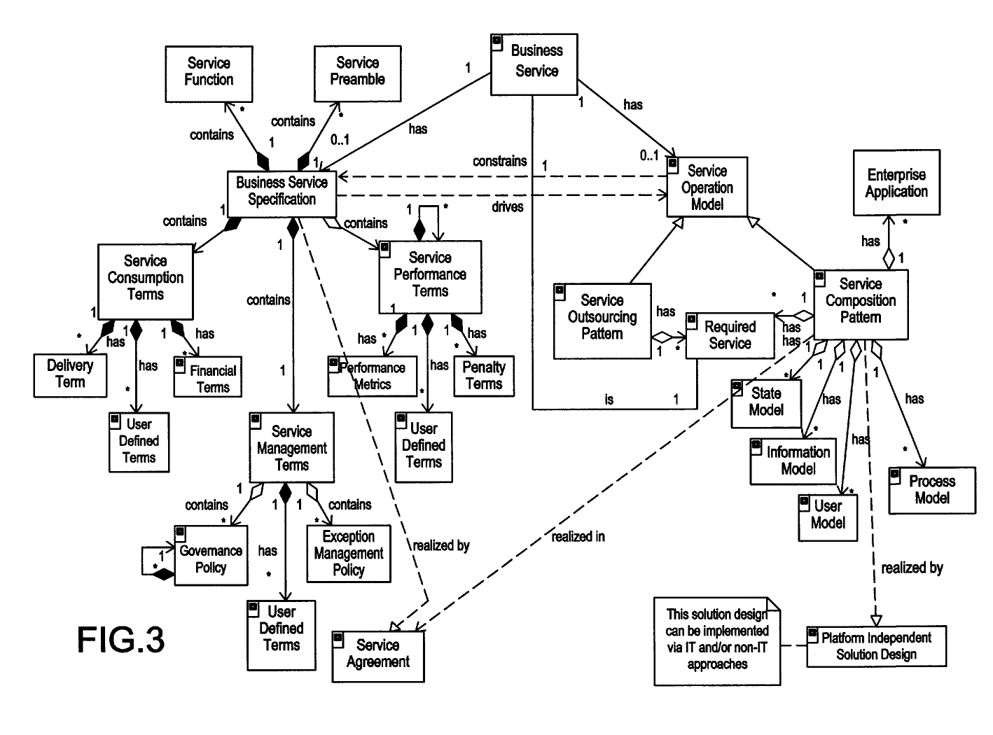

As depicted in the Unified Modeling Language (UML) models in FIGS. 2 and 3, the USM includes two specifications associated with each service: (1) the business specification of the service and (2) the service operation model. There are no limitations on the number of business specifications and service operation models associated with a business service. Thus, a business service can have multiple business specifications and multiple service operation models. The service provider can use their own business logic to associate a business specification of the service with an appropriate service operation model during service provisioning.

The business specification of the service and the service operation model are inter-related. The business specification of the service drives the requirements for a meaningful service operation model. In turn, the service operation model establishes some realistic constraints on what the business specification of the provided service can support in the form of a service agreement.

Specifically, the business specification of a service is a representation that captures a business person's perspective of a business service regarding what the service does, how the service is consumed, how its performance is measured, and how the service is managed. Some or all aspects of the business specification of a service can be described by both the service provider and the service consumer. The business specification of a service then becomes the basis for matching the service consumer's needs with the service providers' services. The business specification of a service also forms the basis of the service agreement between the service provider and the service consumer.

A business service provides value-added functions (service functions) that are invoked by service requesters. The description of these functions and how one interacts with the service function is captured within the business specification of a service.

A service operation model is a representation that describes how each service function should be realized using various operational elements including enterprise applications, process flow models, user roles, business artifacts, information model, state model of the service, other required services, etc. This specification allows the service provider to communicate the description of each service function operations to the service implementer and, if required, to the service consumer.

Service implementation is the actual implementation of the service provided by the service provider. Although the entity that designs and implements the service implementation is not specifically modeled in the USM business service design FIG. 2, one should assume that it exists and is responsible for implementing the service based on the service operation model from the service provider. This entity can be within the same organization as the service provider or can be an external partner. This entity could be a person, organization, or software that is capable of designing and building the service implementation.

A solution composition is a representation that describes a platform-independent solution design used to create a service implementation. Elements within solution composition are based on UML and include entities such as use cases, data graphs, state machine models, web services, user interaction models, etc.

As mentioned earlier, the business specification of a service captures a business person's perspective of a business service including both its functional as well as non-functional aspects. Refer to FIG. 3 for exemplary embodiments. These include a structured description of what the service does, how the service is consumed, how its performance is measured, and how the service is managed. Both the service provider and the service consumer can create their own business specifications of a service to either express capabilities of the service (service provider view) or express service requirements (service consumer view). The elements within the business specification of a service that support this expression are given below. The representation schema for a business specification of a service leverages existing approaches to specifying these elements using a combination of data specification (e.g. XML schema) and business rules. The use of domain-specific templates to express business specifications of a service will facilitate faster adoption of this aspect of service-oriented business modeling.

The service preamble element contains a general description of the service. The preamble includes a service description, which includes service name, which is an identifier associated with a service which makes this service unique, capabilities, where used, etc. Although the service name should give an indication of its capabilities, the service consumer and service provider can each have their own nomenclature for naming services. Additionally, the preamble includes provider information, which includes provider name, contact information, etc., and other user-defined information.

Service functions include functions provided by the service and exposed to the service consumer along with details of how to interact with the service functions. Although not necessary, providing the input and output artifacts for each function will further improve understanding of the service's capabilities. The service consumer and service provider can each have their own nomenclature for naming service functions.

The service function description includes a description of the service function that helps in searching and identifying services. Again, the service provider's and service consumer's description of a service function will differ, but should be close enough for understanding the intent.

The interaction type refers to the complexity of the interaction in consuming a service function, e.g., whether it is a simple request-response type of interaction or a more complex conversation type interaction. If the service interaction is conversational, then a service conversation model in the form of a public process is associated with the service function. RosettaNet PIPs are an example of conversational service interaction.

Delivery terms and conditions describe how the service will be delivered including elements such as duration of service, delivery mode, delivery exception handling, etc.

Financial terms and conditions describe how the service will be metered and charged including elements such as currency, exchange rate, payment schedule, discount schedule, rebates, cancellation fees, etc.

User-defined terms and conditions, shown in three places in FIG. 3 but occurring wherever necessary in the business specification of a service, describe additional terms for user-defined situations to include issues of specific concern to the service provider and service consumer. This expresses specifications not captured by the standard elements within the business specification of a service.

The business specification of a service also defines the service performance terms, including the performance metrics, reporting, performance failure penalties and user-defined terms and conditions.

Performance metrics describe how well the service will perform in terms of metrics such as speed, quantity, quality of service, error rates, etc. The actual content depends on the service function and the context in which it is consumed.

Reporting relates to what and how the service consumption information is reported to the service consumer and with what frequency.

Performance failure penalties provide a definition of service performance failures and the associated schedule of compensation to the service consumer for non-performance.

The business specification of a service also defines the service management terms, including the governance policy, exception management, and user-defined terms and conditions.

The governance policy expresses rules associated with providing and consuming services. From a service provider perspective, this describes which services are exposed publicly and which services are private. From a service consumer perspective, this describes which class of service requesters associated with the service consumer can request certain services. These are just some of the governance-related issues expressed within the governance policy section of the business specification of a service.

Exception management relates to the process for resolving exception situations such as escalation procedures, etc.

The service agreement represents the realization of the business specification of a service and in some instances the portion of the service operation model that is visible to and acceptable to both parties. The service agreement can be different for each service provider-service consumer relationship. The service agreement can be used to validate whether the service operations will indeed meet the business requirements established between the two parties. It will also be used to model the service transaction monitoring solution.

The representation schema for the business specification of a service should leverage existing approaches to modeling these specifications using a combination of data specification (e.g. XML schema) and business rules. The use of domain-specific templates to express business specifications will facilitate faster adoption of this aspect of service-oriented business modeling. The present invention includes a new XML vocabulary, the Business Services Description Language (BSDL), to serve as an organizing mechanism and has the ability to support multiple XML vocabularies within a services specification document.

The service operation model of the present invention describes how the various service functions should be realized from the perspective of a business architect. The associated business specification of the service serves as a guide in making decisions affecting the service operation model to ensure that the provided service can indeed meet what is promised in the service agreement.

The present invention provides two main approaches to creating service operations that support all situations encountered by any service provider. These two approaches are (1) where the service provider uses a service composition pattern to develop the service, and (2) where the service provider chooses to outsource the service to a third-party vendor. All other approaches can be modeled as specializations of these two approaches, as described below.

The service composition pattern describes how a service function should be composed from operational elements including process models, business artifacts, user roles, information models, business applications, other required services from internal or external sources, and other resources. This is a relatively complex service realization pattern that includes choreography of services and the sequence of business tasks performed by business applications and human tasks governed by business rules. Depending on the service granularity, one or more of the operational elements will be required to specify the service composition. For example, business architects in many cases will use process models, business artifact models, and required services models to adequately specify composition of large-grained services. On the other hand, solution architects may require all the operational elements to specify a service operation in more detail. The operational elements within the service operation model are described below.

The process model describes the dynamic behavior of a service function in providing the requested function. Usually, the process model is ultimately decomposed into several levels of sub-processes and business use cases. However, in service-oriented business modeling, one can consider each step in the process model (i.e., sub-process or a business use case) to be a candidate for a service task to be performed by a service function. So the decision to further decompose a sub-process into lower level business tasks should be undertaken only if providing the associated lower-level services is also within the scope of the service provider. Otherwise, this sub-process decomposition should be left to the service provider for whom it is in scope. This questioning of which services to build versus which services to buy at each stage of the decomposition is an important aspect of the service-oriented business modeling approach. This distinguishes it from the traditional approach to business transformation, wherein the entire process is decomposed into several levels of sub-processes and business use-cases and questioning which business tasks should be service tasks is done later.

In case of complex service interactions (conversational model), a public process describing the steps involved in service function consumption along with responsibilities and commitments is shared amongst the various parties. This information is necessary so each party can prepare to perform its part during the service function consumption.

Enterprise applications describe the enterprise application modules that would be used within the service operation. This information can then be used by the solution architects to compose the solution design.

The information model describes the information needed for the process to operate. This also includes information regarding any business artifacts associated with the service operation. Granularity of the information model will depend on the process decomposition level.

The state model describes the states associated with (1) key business artifacts in the process, and (2) the service itself The business artifact states allow one to model state-dependent business logic within the service. The service states help in modeling stateful services that support conversational interaction and can remember information from previous invocations.

The user model describes roles involved in role-sensitive interaction during service function consumption.

As mentioned earlier, a step in the process model (i.e., sub-process or a business use case) is considered as being either a regular business task or a service task. The service task is a specialized business task that is performed by a service function. Services that provide these functions are termed “required services” as in required by a business process. For a business task designated as a service task, a business specification for the required service is created. In doing so, the service provider now begins playing the role of a service consumer for the required service. This business specification will be used to search for appropriate services from internal and/or external sources. This role reversal during service operation modeling from a service provider to a service consumer of required services results in a service hierarchy that links the provided service to downstream required services.

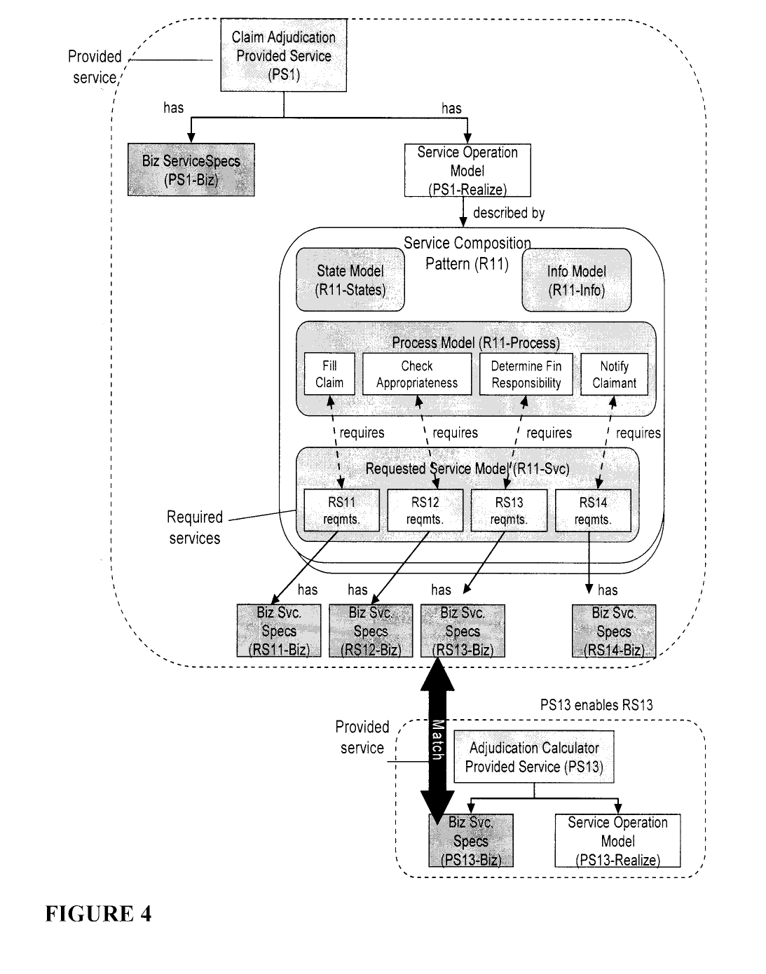

FIG. 4 shows an example of such a service hierarchy from healthcare insurance. The service operation model of the claim adjudication service (PS1) contains a service task called determine financial responsibility. The business specification for the required service (e.g., RS13-Biz) that will provide the service function to perform this service task results in locating an adjudication calculator service (PS13) available from a third party service provider.

An important observation is the role of the business specification for a required service to link a provided service to its downstream required services. This allows a large-grained service to theoretically communicate its business objectives through the business specification to downstream services through recursion and thereby achieve business alignment.

It is also significant to note that the business specification of a service provides the same requirements to both internal service implementers and external service providers. This is an important consideration for service-oriented businesses who would like flexibility in sourcing the requested services for competitive advantage.

Based on the above discussion, it is reasonable to model highly automated service operations such as those provided through packaged applications or legacy applications as specializations of the service composition pattern. For example, an application or IT solution for approving credit-card transactions would fall under this approach.

The service outsourcing pattern of service operation supports the notion that the service provider may choose to outsource the implementation of its provided service. In this scenario, any service request to the service provider is immediately forwarded to another third party service provider. In this pattern, the service operation model includes only details such as the business specification of the outsourced service in order to search and identify appropriate third party services.

The service operation model provides the requirements for developing a platform-independent solution to realize the service. The solution composition can be designed using a variety of model-driven development approaches as well as solution composition patterns, such as Patterns for E-business and MDBT Engagement Pattern from IBM Research. The following discussion describes two examples of the Unified Service Model (USM) usage, in accordance with certain exemplary embodiments of the present invention, in the context of service-oriented business modeling—one from the perspective of a service provider and the other from the perspective of a service consumer. Note, the context in these examples is business modeling and so no reference is made to either solution modeling or implementation.

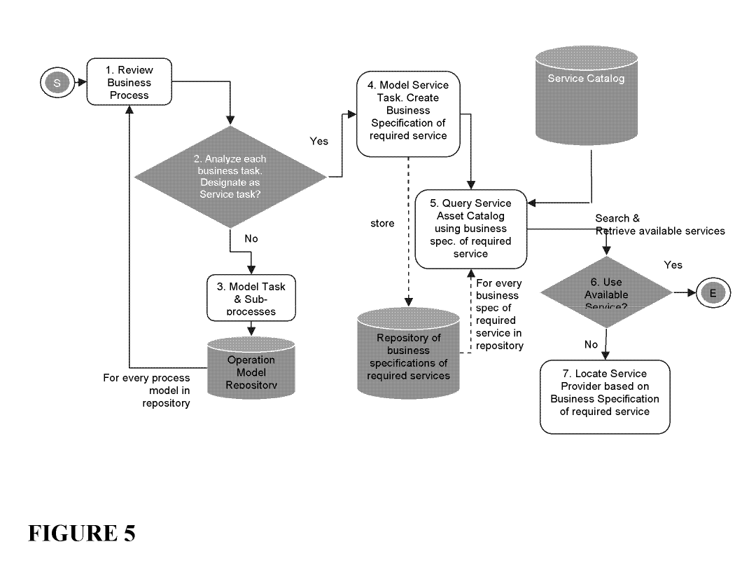

FIG. 5 depicts a flowchart associated with modeling a service-oriented business by a service consumer. The details of the method are described below.

First, a business process model is created for the service consumer. The dynamic behavior of an enterprise is represented in its business processes. It is assumed that the business process of interest has been identified separately using one or more of the several available approaches, such as strategic analysis based on Componentized Business Model (CBM) from IBM. The process model shows the sequence of business tasks that, depending on the granularity, can be further decomposed into several levels of sub-processes. A service task is a business task that can be performed by a service function in a service from a service provider.

Next, a decision is made about using the service tasks. The decision whether to use services to perform certain business tasks has to be made. It is assumed that there exist various techniques and approaches to help make this decision.

Then, business tasks and subprocesses are modeled within the process model. For those business tasks and sub-processes that are not service tasks, the traditional process modeling approach is applied. These process models are stored in the operation model repository. Each level of process model in the repository is reviewed as above. This recursive approach allows one to model service usage at any level within a decomposed process.

Next, the service tasks are modeled within the process model. For each service task, the service consumer specifies the business specification for a service required to perform the service task, which is then stored in the repository of business specifications for required services These business specifications can be used to either locate appropriate existing services or can be used by either internal or external service providers to realize a required service, if such a required service doesn't already exist.

Then, a provider's service catalog is queried for reusable service assets. The service catalog contains business specifications of available services. Based on the business specification for the required service, one should be able to search for available services that can be reused. The result of this search is a set of business specifications of available services that meet the search criteria to varying degrees.

After one or more providers' service catalogs are queried, a decision is made about reusing available services. It is assumed that there exist various techniques and approaches to make reuse decisions regarding existing services, especially when the match between service requirements and service capabilities is less than perfect. If an available service will be reused, then that represents the end of the path for the service task.

For service tasks that cannot be supported by available services, the decision about service realization now becomes a choice of source. The provider for a required service can be within or outside the service consumer organization. However, in either case, the same business specification of the required service can be used.

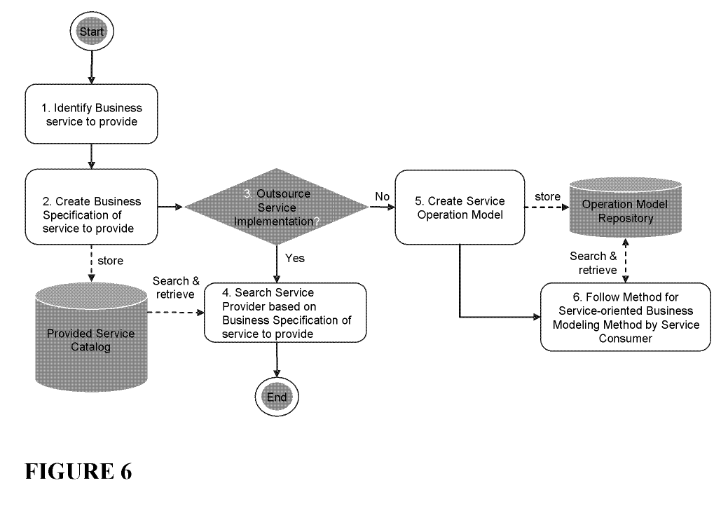

FIG. 6 depicts a flowchart associated with modeling a service-oriented business by a service provider. The details of the method are described below.

First, a business service to be provided is identified. The opportunity to provide a business service can be based on a consumer request or based on market needs, capability analysis, strategic analysis based on Componentized Business Model (CBM), etc.

Next, the business specification for the provided service is created and stored in the provider's service catalog. Depending on how the business service is identified, the business specification of the provided service can be created by either the service provider or a service consumer needing the business service. In either case, the business specification of the service serves as a description of the business aspects of the service including description of service functions, service consumption terms, service performance terms, and service management terms. Other terms could be included, depending on the service context.

Then, a decision about sourcing the service implementation is made. The service provider has a choice regarding how best to implement a service—either implement the service themselves or get a third party service provider to implement the service.

If the service implementation is to be outsourced, then a service provider is searched. In situations where the service implementation is outsourced, the service operation model consists primarily of identifying existing services from appropriate third party service providers or identifying appropriate service providers capable of providing a business service in accordance with the business specification. The search for such service providers is based on a variety of criteria including their capabilities and special expertise, lower costs, need for speed in bringing service to market, etc.

If the provider is to implement the service itself then the detailed service operation model is created. In situations where the service implementation is done in-house, the service operation modeling step includes creating the business process model and the information model, identifying user roles, creating a state model of the service and identifying key business artifacts. The service operation model is created using the operation modeler tool and stored in the service operation model repository. The operation model repositories of FIGS. 5 and 6 may be the same or different.

Having created the business process model as part of the service operation model, the service provider can now play the role of a service consumer as discussed above, including identification of appropriate service tasks and creating business specifications for required services. This role reversal from service provider to service consumer during service operation modeling helps build a service hierarchy based on recursion. This should support the flow of business objectives of a provided service to downstream required services, thereby better aligning them with provider's business strategy.

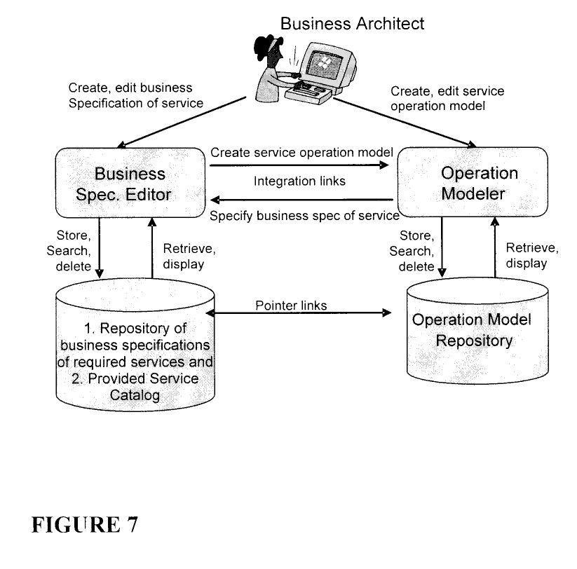

FIG. 7 illustrates two main tools used in the service-oriented business modeling - business specification editor (BSE) and operation modeler. These tools are integrated so that a user can move seamlessly from modeling the business specification of a service to its related service operation model and vice-versa. These tools are supported by appropriate repositories to store the models created.

BSE supports the creation and editing of the business specification of a service. Also, through the integration of BSE with appropriate operation modeling tools, such as IBM's Websphere Business Modeler, the associated service operation model can be created and edited. BSE capabilities include: service provider can model the business specifications for offered services; service consumer can specify the business specifications of services to consume; service provider or service consumer can review a portfolio of business services; service provider can initiate creation of a service operation model within an appropriate operation modeling tool such as IBM's Websphere Business Modeler; service provider, during service operation modeling, can analyze/compare the business specification of a required service with vendor's service agreements associated with required services. The service provider or service consumer can store the business specification details in a repository of business specifications of services. The service provider or the service consumer can search for existing business services within an available services catalog and retrieve the business specification of available service assets.

The service provider or service consumer can create a service agreement from the business specification of a service. Also, this tool provides the ability to export the business specification of a service documents to other tools and the ability to import the business specification of a service from other tools.

The operation modeler, such as IBM's Websphere Business Modeler, is used to create the service operation model. By integrating it with the Business Service editor, one can model the business specifications of the required services from within the service operations model. The operation modeler provides the ability to model dynamic behavior of the service function, including its process model, business information, organizational roles, and business rules; the ability to export service operation model documents to other tools; the ability to import service operation model from other tools; the ability of the service consumer to initiate the creation of a business specification of a required service within BSE during service operation modeling; and the ability to search, retrieve, and list various process models in a operation model repository.

The present invention provides a Business Services Description Language (BSDL), which is an XML vocabulary to describe business services in a precise way. It satisfies the precision and formality needs of the Unified Service Model (USM). The BSDL captures, directly or indirectly, all aspects of a service that are needed to define its business specification and support its realization. The specification and realization of services is a complex effort that may include the collaboration and interaction of multiple role players, tools and processes. BSDL is established to support the formal expression of information about all aspects of a service. Hence, it enables the ability to bind together multiple disparate elements that specify, create and utilize services. These elements can come from existing XML vocabularies where necessary or customary. The language is used for modeling business specifications based on USM within the business service editor and is equally applicable to both a service consumer and a service provider.

In view of the above, the Unified Service Model (USM) for Service-oriented Business Modeling is capable of representing services consumed within business processes at all levels within the process hierarchy. This approach avoids the arbitrary fragmentation of services into business services and IT services depending on where in the process hierarchy a particular service is consumed.

Additionally, the USM has a feature that allows representing the connection between a service model at one level of abstraction and services consumed from the next level down in the process hierarchy, thereby allowing the service models to be connected in a hierarchical tree structure. This feature allows decisions at higher levels in the hierarchy to influence architectural decisions in lower levels of service design.

Furthermore, elements within the USM can support communication between multiple roles during design time, primarily service consumer and service provider as well as service provider and service implementer. Also, the USM elements within a service agreement can help govern the conditions associated with a service transaction during service execution.

Moreover, the USM advances the notion that business services and IT services are essentially different views of the same service. By observing services in their totality, holistically embracing business intent and IT realization, the arbitrary separation of business services and IT services is not required.

Another advantage of the present invention is that the USM captures a business service specification in a formal schema called Business Service Description Language (BSDL), and retains that specification throughout the realization process such that the business context is always expressed within the service, thus assuring a consistent coupling between the business specification and service realization views.

Finally, the USM and its formal representation, BSDL, enable the ability to integrate multiple disparate software tools and applications that specify, create and utilize services.

While the invention has been described in terms of several exemplary embodiments, those skilled in the art will recognize that the invention can be practiced with modification within the spirit and scope of the appended claims.

Further, it is noted that, Applicants' intent is to encompass equivalents of all claim elements, even if amended later during prosecution.

What is claimed is:

1. A method of modeling a service-oriented business, comprising:
identifying a business service to provide based on at least one of a consumer request, market needs, and capability analysis;
creating a business specification for the provided service, the business specification of a service specifying business requirements for the service;
the business specification of a service comprising details of the business service including a description of a functions of the business service, service consumption terms, service performance terms, and service management terms;
storing the business specification of the service for each of the service tasks in a service catalog;
creating and reviewing a business process model for each service function, said business process model providing a sequence of steps in the business process, but not decomposing each of said steps into smaller steps until said steps are resolved through the method;
analyzing each of said steps to determine which shall use service tasks;
searching one or more service catalogs to find service offerings that perform at least some of said steps;
process modeling each of said steps that are not using service tasks, said process modeling being suitable for communicating between a service provider and a service implementer;
storing a process model for each of said steps that are not using service tasks in a operation model repository;
creating a business specification of a service for each of said steps that are using service tasks based on at least one of a service provider and a service consumer, said business service specification being suitable for communication between a service consumer and the service provider, said business service specification specifying service requirements for said service task, said business service specification enabling recursive decomposition of the service, said business service specification comprising details of a business service including a description of a function of the business service, service consumption terms, service performance terms, and service management terms; and
storing said business service specification for each of said service tasks that are being used in a repository of business specifications of services.

2. The method of claim 1, wherein said business service specification further comprises a service preamble, said service preamble comprising a service description and service provider information including a name of the service provider and contact information for the service provider.

3. The method of claim 1, wherein said description of the function of the business service comprises a name of the functions, a description of the complexity of the functions, and input and output artifacts associated with the function.

4. The method of claim 1, wherein said service consumption terms comprise:
delivery terms and conditions, which describe a duration of the service, a delivery mode of the service, and delivery exception handling of the service; and
financial terms and conditions including currency, exchange rate, payment schedule, discount schedule, rebates and cancellation fees.

5. The method of claim 1, wherein said service performance terms comprise:
performance metrics measuring said service performance including speed, quantity, quality of service and error rates;
a manner in which service consumption information is reported to the service consumer; and
service performance failure penalties.

6. The method of claim 1, wherein said service management terms comprise:
governance policies including rules associated with providing and consuming services; and
exception management including a process for resolving exception situations.

7. The method of claim 1, wherein said service provider is integrated into the organization of the service consumer.

8. The method of claim 1, wherein said service provider is a separate organization from said service consumer.

9. The method of claim 1, wherein said reviewing the business process model and said analyzing each of said steps is performed with a tool that integrates a business service editor and an operation modeler, allowing a business architect to model the business specification of a provided service and its service operation model while also allowing one to model the business specification of required services identified within the service operation model.
